(19) United States
(12) Patent Application Publication
(10) Pub. No.: US 2015/0103080 A1
(43) Pub. Date: Apr. 16, 2015

(54) COMPUTING DEVICE AND METHOD FOR SIMULATING POINT CLOUDS

(71) Applicants: FuTai Hua Industry (Shenzhen) Co., Ltd., Shenzhen (CN); HON HAI PRECISION INDUSTRY CO., LTD., New Taipei (TW)

(72) Inventors: CHIH-KUANG CHANG, New Taipei (TW); XIN-YUAN WU, Shenzhen (CN); HENG ZHANG, Shenzhen (CN)

(21) Appl. No.: 14/512,566

(22) Filed: Oct. 13, 2014

(30) Foreign Application Priority Data
Oct. 14, 2013 (CN) 201310476511.6

(51) Int. Cl. G06T 11/20

(52) U.S. Cl. CPC G06T 11/20
USPC 345/441

(57) ABSTRACT

A computing device and a method simulate point clouds of a measurement machine. The computing device uses triangle to triangulate the point clouds of the measurement machine. The computing device obtains images of the measurement machine from the scanner, and maps the obtained images on the triangulated point clouds of the measurement machine to generate a model of the measurement machine. The computing device defines a moving component in the model of the measurement machine. The moving component can move within a predetermined range when the model of the measurement machine is performed by the computing device.

### CROSS-REFERENCE TO RELTATED APPLICATIONS

This application claims priority to Chinese Patent Application No. 201310476511.6 filed on Oct. 14, 2013, the contents of which are incorporated by reference herein.

### FIELD

The present disclosure relates to simulation technology, and particularly to a computing device and a method for simulating point clouds of an object.

### BACKGROUND

Computerized numerical control (CNC) machines are commonly used to process various objects (for example, a shell of a mobile phone). However, the CNC machine may fail after a large number of uses. For example, a blade of the CNC machine may need to be periodically changed.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of an example embodiment of a computing device.

FIG. 2 is a block diagram of an example embodiment of a point cloud simulation system included in the computing device.

FIG. 3 shows a plan view of an example of a triangulated point cloud.

FIG. 4 is a flowchart of an example embodiment of a method for simulating point clouds.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented. The term “module” refers to logic embodied in computing or firmware, or to a collection of software instructions, written in a programming language, such as, Java, C, or assembly. One or more software instructions in the modules may be embedded in firmware, such as in an erasable programmable read only memory (EPROM). The modules described herein may be implemented as either software and/or computing modules and may be stored in any type of non-transitory computer-readable medium or other storage device. Some non-limiting examples of non-transitory computer-readable media include CDs, DVDs, BLU-RAY™, flash memory, and hard disk drives. The term “comprising” means “including, but not necessarily limited to”; it specifically indicates open-ended inclusion or membership in a so-described combination, group, series and the like.

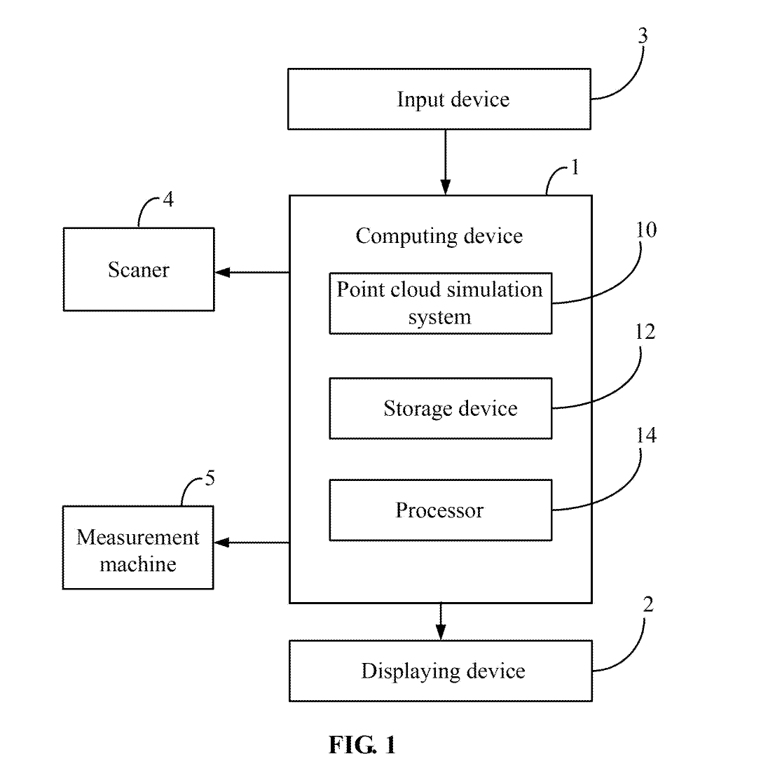

FIG. 1 illustrates a block diagram of an example embodiment of a computing device 1. In the embodiment, the computing device 1 provides various functional connections to connect with a displaying device 2, an input device 3, a scanner 4, and a measurement machine 5. The computing device 1 provides a user interface, which is displayed on the displaying device 2. One or more operations of the computing device 1 can be controlled by a user through the user interface. For example, the user may input an ID and a password using an input device 3 (e.g., a keyboard and a mouse) into the user interface to access the computing device 1. The scanner 4 is used to scan the measurement machine 5 to obtain point clouds of the measurement machine 5. The point clouds are three-dimensional. That is, each point in the point clouds includes an X-axis value, a Y-axis value and a Z-axis value. Furthermore, the scanner 4 is used to capture images of the measurement machine 5. The computing device 1 generates a model of the measurement machine 5 according to the point cloud of the measurement machine 5 and the images of the measurement machine 5. The displaying device 2 further displays the model of the measurement machine 5, so that the model of the measurement machine 5 can be visually checked by the user. The computing device 1 can be, but is not limited to, a tablet computer, a server, a personal computer or any other computing device. The scanner 4 can be, but is not limited to, a three-dimensional scanner capable of emitting light which is projected onto the measurement machine 5. The measurement machine 5 can be, but is not limited to, a CNC machine. In the example embodiment, the computing device 1 includes, but is not limited to, a point cloud simulation system 10, a storage device 12, and at least one processor 14. FIG. 1 illustrates only one example of the computing device 1, and other examples can comprise more or fewer components than those shown in the embodiment, or have a different configuration of the various components.

In at least one embodiment, the storage device 12 can be an internal storage device, such as a flash memory, a random access memory (RAM) for temporary storage of information, and/or a read-only memory (ROM) for permanent storage of information. The storage device 12 can also be an external storage device, such as an external hard disk, a storage card, or a data storage medium. The at least one processor 14 can be a central processing unit (CPU), a microprocessor, or other data processor chip that performs functions of the computing device 1. The storage device 12 stores the three-dimensional point cloud of the measurement machine 5 and the images of the measurement machine 5.

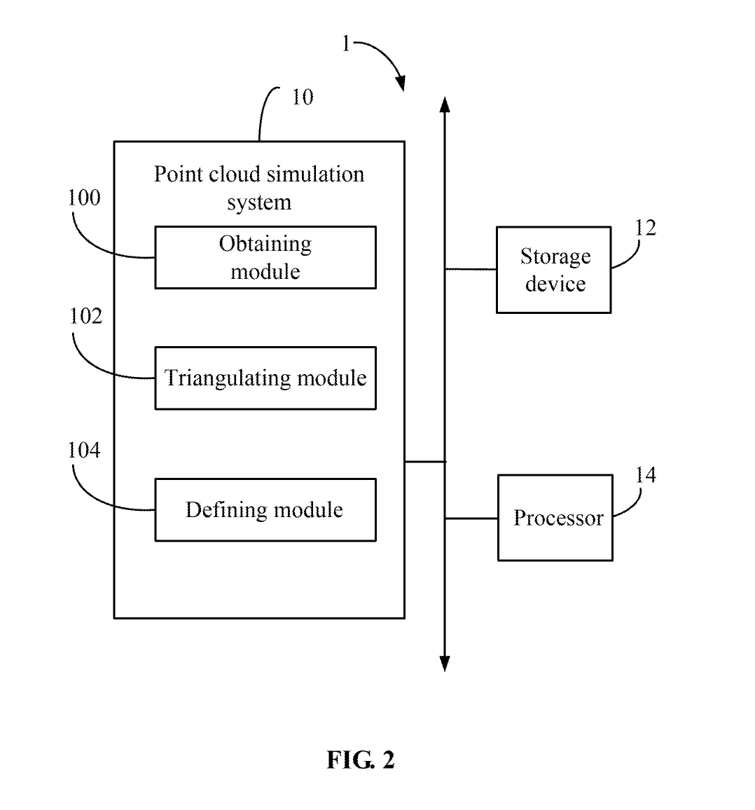

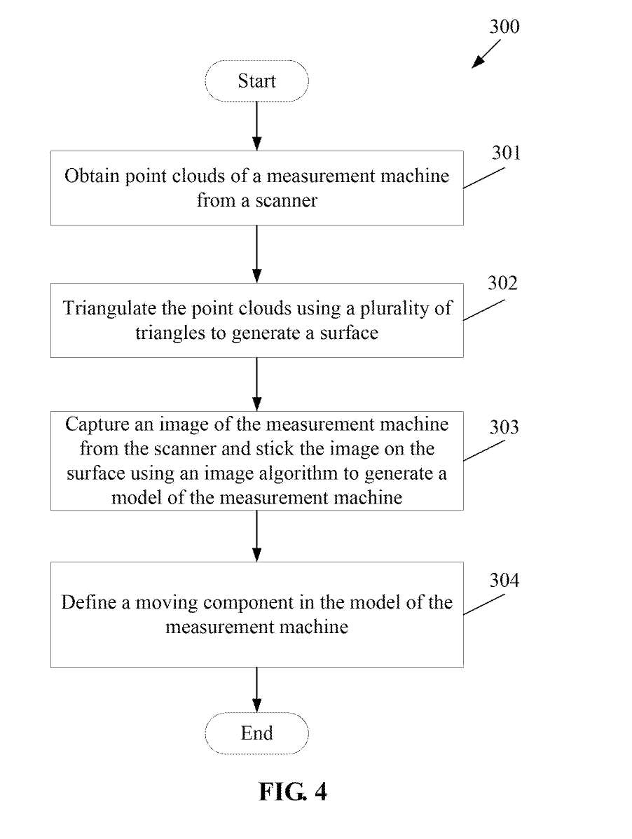

FIG. 2 illustrates a block diagram of an example embodiment of the point cloud simulation system 10 included in the computing device 1. In at least one embodiment, the point cloud simulation system 10 can include, but is not limited to, an obtaining module 100, a triangulating module 102, and a defining module 104. The modules 100-104 can comprise computerized instructions in the form of one or more computer-readable programs that can be stored in a non-transitory computer-readable medium, such as the storage device 12, and be executed by the at least one processor 14 of the computing device 1. Detailed descriptions of functions of the modules are given below in reference to FIG. 4.

FIG. 4 illustrates a flowchart of an example embodiment of a method for simulating point clouds. In an example embodiment, the method is performed by execution of computer-readable software program codes or instructions by at least one processor of a computing device.

Referring to FIG. 4, a flowchart is presented in accordance with an example embodiment. The method 300 is provided by way of example, as there are a variety of ways to carry out the method. The method 300 described below can be carried out using the configurations illustrated in FIGS. 1 and 4, for example, and various elements of these figures are referenced in explaining example method 300. Each block shown in FIG. 4 represents one or more processes, methods, or subroutines, carried out in the method 300. Furthermore, the illustrated order of blocks is illustrative only and the order of the blocks can be changed. Additional blocks can be added or fewer blocks may be utilized without departing from this disclosure. The example method 300 can begin at block 301.

In block 301, the obtaining module 100 obtains point clouds of the measurement machine 5 from the scanner 4. In at least one embodiment, the scanner 4 scans each component of the measurement machine 5 to obtain point clouds of each component. The point clouds of the measurement machine 5 include the point clouds of each component of the measurement machine 5. In some cases, the measurement machine 5 is torn down to a plurality of components. The scanner 4 scans each component after the disassembly of the measurement machine 5.

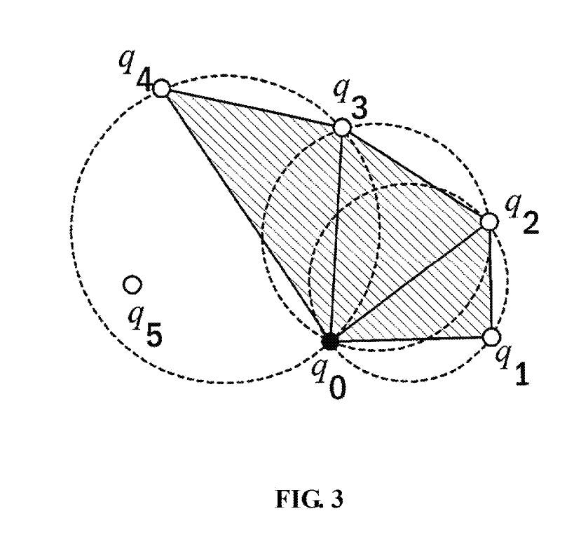

In block 302, the triangulating module 102 triangulates the point clouds of the measurement machine 5 using a plurality of triangles. In at least one embodiment, the point clouds of the measurement machine 5 can be represented by the plurality of triangles after triangulation. Each triangle is determined to be qualified when the triangle meets two following conditions: (1) there are no any points inside a circumcircle of the triangle, and (2) an angle between a vector of the triangle and another vector of each adjacent triangle does not exceeds a predetermined curvature (e.g., a 90 degrees), where the adjacent triangle and the triangle shares the same line. For example, as shown in FIG. 3, another point q5 locates inside the circumcircle of the triangle which is generated by the points q0, q3 and q4, then the triangle q0-q3-q4 does not meet the first condition (1) and the triangle q0-q3-q4 is determined to be unqualified. As yet shown in FIG. 3, the triangle q0-q2-q3 and the triangle q0-q1-q2 meet the first condition (1), both the triangle q0-q2-q3 and the triangle q0-q1-q2 include the same line q0-q2, the triangle q0-q1-q2 are determined as the adjacent triangle respect with the triangle q0-q2-q3. Further, if the angle between the vector of the triangle q0-q2-q3 and the vector of the triangle q0-q1-q2 does not exceed a predetermined curvature, the triangle q0-q2-q3 meets the second condition (2) and is determined to be qualified. In additions, there are still a huge of qualified triangles after triangulation, some qualified triangles are discarded for simplifying later calculation. For example, if a curvature of the qualified triangle falls in a predetermined range (e.g., 70 degrees to 90 degrees), the qualified triangle is kept. If a curvature of the qualified triangle falls in another predetermined range (e.g., 0 degree to 10 degrees), the qualified triangle is randomly selected to be kept, for example, a predetermined percentage (30%) of the qualified triangles which the curvature of each qualified triangle falls in a range of 0 degree to 10 degrees are randomly selected to be kept.

In block 303, the obtaining module 100 obtains images of the measurement machine 5 from the scanner 4. In at least one embodiment, the scanner 4 captures each component of the measurement machine 5 to obtain an image of each component. The images of the measurement machine 5 include the image of each component. In some cases, the measurement machine 5 is torn down to a plurality of components. The scanner 4 captures each component after the disassembly of the measurement machine 5. The obtaining module 100 further maps the obtained images on the triangulated point clouds of the measurement machine 5 to generate a model of the measurement machine 5. The model of the measurement machine 5 is displayed on the displaying device 2, so that a user can amend the model of the measurement machine 5 by viewing the model of measurement machine 5 in real-time.

In block 304, the defining module 104 defines a moving component in the model of the measurement machine 5. The defining module 104 searches the moving component from the model of the measurement machine 5 according to coordinates of the moving component and assigns a predetermined color (e.g., red color) to the moving component. The moving component is capable of moving within a predetermined range if the model of the measurement machine 5 is performed by the computing device 1. The computing device 1 uses the model of the measurement machine 5 to simulate operations of the measurement machine 5. For example, the simulated operations of the measurement machine 5 may cut a simulated object using the moving component.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in particular the matters of shape, size and arrangement of parts within the principles of the present disclosure, up to and including the full extent established by the broad general meaning of the terms used in the claims.

What is claimed is:

1. A computing device, comprising:
at least one processor; and
a storage device that stores one or more programs, which when executed by the at least one processor, cause the at least one processor to:
obtain point clouds of a measurement machine from a scanner coupled to the computing device by scanning the measurement machine with the scanner;
triangulate the point clouds of the measurement machine using a plurality of triangles;
obtain images of the measurement machine from the scanner; and
map the images on the triangulated point clouds of the measurement machine to generate a model of the measurement machine.

2. The computing device of claim 1, wherein each triangle is determined to be qualified when the triangle meets two conditions: (1) there are no any points inside a circumcircle of the triangle, and (2) an angle between a vector of the triangle and another vector of each adjacent triangle does not exceeds a predetermined curvature, and the adjacent triangle and the triangle shares the same line.

3. The computing device of claim 1, wherein the one or more programs further cause the at least one processor to define a moving component in the model of the measurement machine, the moving component capable of moving within a predetermined range when the model of the measurement machine is performed by the computing device.

4. The computing device of claim 3, wherein the moving component in the model of the measurement machine is searched according to coordinates of the moving component and assigns a predetermined color to the moving component.

5. The computing device of claim 3, wherein the moving component in the model of the measurement machine is assigned to a predetermined color to the moving component.

6. The computing device of claim 1, wherein the computing device uses the model of the measurement machine to simulate operations of the measurement machine.

7. A computer-based method for simulating point clouds using a computing device, the simulation method comprising:
obtaining point clouds of a measurement machine from a scanner coupled to the computing device by scanning the measurement machine with the scanner;
triangulating the point clouds of the measurement machine using a plurality of triangles;
obtaining images of the measurement machine from the scanner; and
mapping the images on the triangulated point clouds of the measurement machine to generate a model of the measurement machine.

8. The method of claim 7, wherein each triangle is determined to be qualified when the triangle meets two conditions: (1) there are no any points inside a circumcircle of the triangle, and (2) an angle between a vector of the triangle and another vector of each adjacent triangle does not exceeds a predetermined curvature, and the adjacent triangle and the triangle shares the same line.

9. The method of claim 7, further comprising:
defining a moving component in the model of the measurement machine, the moving component capable of moving within a predetermined range when the model of the measurement machine is performed by the computing device.

10. The method of claim 9, wherein the moving component in the model of the measurement machine is searched according to coordinates of the moving component and assigns a predetermined color to the moving component.

11. The method of claim 9, wherein the moving component in the model of the measurement machine is assigned to a predetermined color to the moving component.

12. The method of claim 7, wherein the computing device uses the model of the measurement machine to simulate operations of the measurement machine.

13. A non-transitory computer-readable medium having stored thereon instructions that, when executed by at least one processor of a computing device, causing the computing device to perform a method for simulating point clouds, the method comprising:
obtaining point clouds of a measurement machine from a scanner coupled to the computing device by scanning the measurement machine with the scanner;
triangulating the point clouds of the measurement machine using a plurality of triangles;
obtaining images of the measurement machine from the scanner; and
mapping the images on the triangulated point clouds of the measurement machine to generate a model of the measurement machine.

14. The non-transitory computer-readable medium of claim 13, wherein each triangle is determined to be qualified when the triangle meets two conditions: (1) there are no any points inside a circumcircle of the triangle, and (2) an angle between a vector of the triangle and another vector of each adjacent triangle does not exceeds a predetermined curvature, and the adjacent triangle and the triangle shares a line.

15. The non-transitory computer-readable medium of claim 13, wherein the method further comprises:
defining a moving component in the model of the measurement machine, the moving component capable of moving within a predetermined range when the model of the measurement machine is performed by the computing device.

16. The non-transitory computer-readable medium of claim 15, wherein the moving component in the model of the measurement machine is searched according to coordinates of the moving component and assigns a predetermined color to the moving component.

17. The non-transitory computer-readable medium of claim 15, wherein the moving component in the model of the measurement machine is assigned to a predetermined color to the moving component.

18. The non-transitory computer-readable medium of claim 13, wherein the computing device uses the model of the measurement machine to simulate operations of the measurement machine.
